(19) United States
(12) Patent Application Publication
(10) Pub. No.: US 2019/0058337 A1
(43) Pub. Date: Feb. 21, 2019

(54) APPARATUS AND SYSTEM FOR PROVIDING A CONNECTED BATTERY

(71) Applicant: HUSQVARNA AB, HUSKVARNA (SE)

(72) Inventor: Ted Wolfram, Vrigstad (SE)

(73) Assignee: HUSQVARNA AB, HUSKVARNA (SE)

(21) Appl. No.: 15/763,195

(22) PCT Filed: Sep. 27, 2016
(86) PCT No.: PCT/IB2016/055776

§ 371 Date: Mar. 26, 2018

(30) Foreign Application Priority Data
Sep. 29, 2015 (SE) 1551240-3

(51) Int. Cl. H02J 7/00; H04Q 9/00

(52) U.S. Cl. CPC H02J 7/0026; H04Q 2209/40; H04Q 2209/88; H04Q 9/00

(57) ABSTRACT

A battery pack (150) may include one or more rechargeable battery cells (350) and processing circuitry (310). The processing circuitry (310) may be configured to control extraction of operational parameters from a device (200) to which the battery pack (150) is operably coupled and wireless communication of the operational parameters from the battery pack (150) to an access point (160). The operational parameters may include at least one parameter that is not determined based on measuring battery parameters. The device (200) is one of a plurality of different devices with which the battery pack (150) is configured to be operably coupled.

### CROSS-REFERENCE TO RELATED APPLICATIONS

This application claims the benefit of Swedish application number 1551240-3 filed Sep. 29, 2015, the entire contents of which are hereby incorporated by reference.

### TECHNICAL FIELD

Example embodiments generally relate to battery technology and, more particularly, relate to a battery that can act as a gateway between a plurality of different devices and various network resources.

### BACKGROUND

Property maintenance tasks are commonly performed using various tools and/or machines that are configured for the performance of corresponding specific tasks. Certain tasks, like cutting trees, trimming vegetation, blowing debris and the like, are typically performed by hand-held tools or power equipment. The hand-held power equipment may often be powered by gas or electric motors. Until the advent of battery powered electric tools, gas powered motors were often preferred by operators that desired, or required, a great deal of mobility. Accordingly, many outdoor power equipment devices are powered by gas motors because they may be required to operate over a relatively large range. However, as battery technology continues to improve, the robustness of battery powered equipment has also improved and such devices have increased in popularity.

The batteries employed in outdoor power equipment may, in some cases, be removable and/or rechargeable assemblies of a plurality of smaller cells that are arranged together in order to achieve desired output characteristics. The groups of smaller cells may be located or housed within a housing to form a battery pack. The battery pack may have physical and electrical design characteristics that determine which devices can be powered by the battery pack. In the past, specific unique battery packs have often been employed for each specific different type of outdoor power equipment or for different brands. Thus, each household or business may have substantially an equal number of battery packs to the number of devices that are powered by such battery packs. This can consume more storage space, and also typically means that a diverse array of different battery chargers is also necessary.

Thus, there is a desire to reduce the diversity of battery pack designs used to power outdoor power equipment. However, there is also a desire to incorporate outdoor power equipment into the ever expanding world of the Internet of Things.

### BRIEF SUMMARY OF SOME EXAMPLES

Some example embodiments may provide a battery pack that is capable of being used with a plurality of different types of power tools such as outdoor power equipment. However, example embodiments may further provide the capability for the battery pack to extract data from the various different types of devices that can be powered by the battery pack. The extracted data can thereafter be stored and/or transmitted to another device, which may be associated with a management entity or a particular user. The battery pack may therefore become a gateway for entry of the device being powered by the battery pack into the Internet of Things.

In one example embodiment, a battery pack is provided. The battery pack may include one or more rechargeable battery cells and processing circuitry. The processing circuitry may be configured to control extraction of operational parameters from a device to which the battery pack is operably coupled and wireless communication of the operational parameters from the battery pack to an access point. The operational parameters may include at least one parameter that is not determined based on measuring battery parameters. The device is one of a plurality of different devices with which the battery pack is configured to be operably coupled.

In another example embodiment, a communications manager for a battery pack comprising one or more rechargeable battery cells is provided. The communications manager may include processing circuitry configured to control extraction of operational parameters from a device to which the battery pack is operably coupled and wireless communication of the operational parameters from the battery pack to an access point. The operational parameters may include at least one parameter that is not determined based on measuring battery parameters. The device is one of a plurality of different devices with which the battery pack is configured to be operably coupled.

In another example embodiment, a system including battery powered devices is provided. The system includes a plurality of different battery powered devices, an access point configured for wireless communication, and a battery pack comprising one or more rechargeable battery cells and processing circuitry. The processing circuitry is configured to control extraction of operational parameters from a selected one of the devices to which the battery pack is operably coupled, the operational parameters including at least one parameter that is not determined based on measuring battery parameters, and wireless communication of the operational parameters from the battery pack to an access point.

Some example embodiments may improve the user experience and/or the efficacy of battery powered equipment.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a concept diagram of a system in which a connected battery may operate in accordance with an example embodiment;

FIG. 2 illustrates a block diagram of circuitry for accomplishing two levels of connectivity for a connected battery in accordance with an example embodiment;

FIG. 3 illustrates a block diagram of processing circuitry of the connected battery in accordance with an example embodiment;

FIG. 4 illustrates a control flow diagram for execution of a shutdown based on battery data extracted from a device in accordance with an example embodiment;

FIG. 5 illustrates a control flow diagram for delayed transmission of operational parameters using a connected battery in accordance with an example embodiment;

FIG. 6 illustrates a control flow diagram for substantially real-time transmission of operational parameters using a connected battery in accordance with an example embodiment;

FIG. 7 illustrates a control flow diagram for identification based configuration of a device using a connected battery in accordance with an example embodiment; and

FIG. 8 illustrates a control flow diagram for remote provisioning of configuration information for a device using a connected battery in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection or interaction of components that are operably coupled to each other.

Some example embodiments may provide for a battery pack that can be useful in connection with battery powered tools or battery powered outdoor power equipment. Outdoor power equipment that is battery powered, and battery powered tools generally, typically include battery packs that have a given voltage or power rating, and have physical characteristics that must match the receptacle of the device that is to be powered. In order to achieve sufficient power, cells of the battery pack may be organized and interconnected (e.g., in an arrangement of series and/or parallel electrical connections) to group the cells within the battery pack in a manner that achieves desired electrical characteristics. The battery pack may be inserted into an aperture (e.g., a receptacle) of the piece of equipment that is to be powered so that the corresponding piece of equipment (e.g., hand-held, ride-on, or walk-behind outdoor power equipment) is enabled to be mobile. However, in some cases, the battery pack may be inserted into a backpack or other carrying implement that the equipment operator may wear, and the backpack may have an interface portion to be inserted into the aperture of the piece of equipment.

The battery pack is typically rechargeable, and may generate heat during charge and/or discharge due to the electrochemical reactions that are employed to produce electricity. Thus, the battery packs and/or their chargers may sometimes incorporate cooling assemblies for preventing heat generation from becoming excessive, and damaging the cells of the battery pack. Accordingly, it should be appreciated that the battery pack generally needs to have a physical structure that supports the cells of the battery pack and cooling equipment (if employed), and that physical structure needs to further incorporate electrical contacts that allow the battery pack to be operably coupled to the electric motor of the device being powered and to the charger that will recharge the battery pack. To make the battery pack suitable for use with a plurality of different types of devices (including outdoor power equipment and chargers), the devices themselves must have consistently designed apertures or other battery receptacles that correspond to the physical characteristics of the battery pack. Moreover, the electrical contacts of the different types of devices must also be suitable for coupling with the contacts of the battery pack when the battery pack is inserted into the respective different types of devices.

Example embodiments are directed to a battery pack that has a physical structure that enables the battery pack to be used with a plurality of different types of devices. However, example embodiments further enable the battery pack to include a communication capability that enables processing circuitry on or associated with the battery pack to be used to extract operational parameters or other such data from or about the device being powered by the battery pack. Furthermore, the battery pack may include communications circuitry that enables the operational parameters to be communicated to one or more network devices. As such, the battery pack is essentially connected and connectable to network resources on a real time or post hoc basis. Thus, the battery pack may be referred to as a “connected battery.”

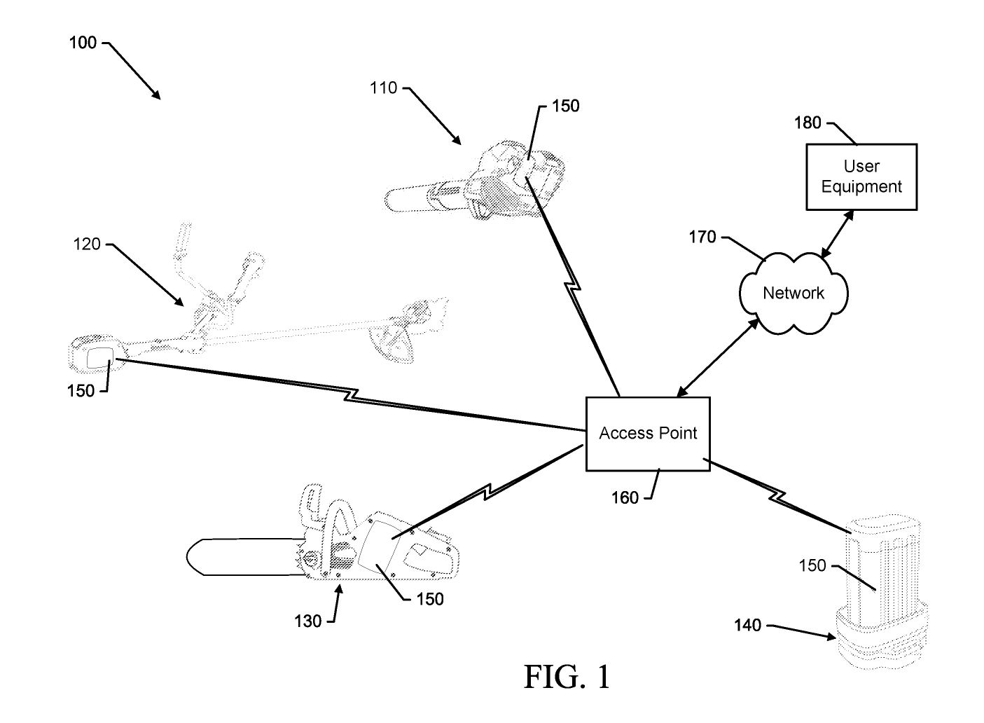

FIG. 1 illustrates a concept diagram of a system 100 in which a connected battery of an example embodiment may operate. As shown in FIG. 1, the system 100 includes a plurality of individual pieces of outdoor power equipment including a first device 110, a second device 120, and a third device 130. The system 100 also includes a charger 140 for charging a connected battery 150 of an example embodiment and an access point 160. The access point 160 enables the devices to be operably coupled to a network 170 to which user equipment 180 may be connected.

In the pictured example, the first device 110 is a blower, the second device 120 is a trimmer, and the third device 130 is a chainsaw. However, these three example devices are merely shown to illustrate the potential for interoperability of the connected battery 150 with a plurality of different types of devices in the outdoor power equipment context. Thus, other pieces of outdoor power equipment could be substituted or added in other examples. For example, string trimmers, hedgers, and even lawn mowers (walk behind and/or ride-on) or other devices could be utilized in connection with other example embodiments. Any battery powered piece of outdoor power equipment that can be operably coupled to the connected battery 150 for both power provision purposes and communication purposes, as described herein, could be part of the system 100, and the system 100 could include as few as a single device or as many as dozens of devices.

Additionally, the fact that three devices that could be powered by the connected battery 150 are shown is merely illustrative of the potential for multiplicity relative to the number of devices that the connected battery 150 can power, and the number of different instances of the connected battery 150 that can communicate with the access point 160. Moreover, it should further be appreciated that one instance of the connected battery 150 could be charged using the charger 140, and that same instance of the connected battery 150 could power each respective different one of the first, second and third devices 110, 120 and 130 in any order while charged. After charge depletion, the instance of the connected battery 150 could be recharged at the charger 140. Alternatively, separate instances of the connected battery 150 could power each respective one of the first, second and third devices 110, 120 and 130 while a fourth instance of the connected battery 150 is charging at the charger 140.

In the example in which a single instance of the connected battery 150 is used with each device, the single instance of the connected battery 150 may communicate with the access point 160 while powering each of the first, second and third devices 110, 120 and 130, and while being charged on the charger 140. Meanwhile, in an example in which multiple instances of the connected battery 150 are employed to power respective ones of the first, second and third devices 110, 120 and 130, each such instance may communicate with the access point 160 simultaneously or in sequence.

The connected battery 150 is shown communicating with the access point 160 while installed for powering each of the first, second and third devices 110, 120 and 130, and being charged by the charger 140. However, it should be appreciated that the connected battery 150 may also communicate with the access point 160 when not installed or being charged in some alternative examples. Moreover, in some cases, the connected battery 150 could be used in different ones of the first, second and third devices 110, 120 and 130 at respective different times and extract operational parameters from each respective device while installed therein. However, the operational parameters may be stored locally at the connected battery 150 for communication to the access point 160 at some later time.

It should also be appreciated that the connected battery 150 may have different triggers or stimuli that cause the connected battery 150 to communicate with the access point 160. In some cases, initiation of connection of the connected battery 150 with a device (e.g., the first, second and third devices 110, 120 and 130, or the charger 140) may trigger communication with the access point 160. Alternatively or additionally, termination of connection may trigger communication, or various time or event based triggers may cause the connected battery 150 to connect to the access point 160. However, in some cases, the access point 160 may poll instances of the connected battery 150 for data, or may otherwise initiate communication with one or more instances of the connected battery 150.

Once data (such as the operational parameters) has been extracted from devices to which the connected battery 150 is operably coupled and has been communicated to the access point 160, the data may be accessible by user equipment 180 via the network 170. The network 170 may therefore be a local area network, or a wide area network (e.g., the Internet), and the user equipment 180 could be a personal computer or laptop, a smart phone or tablet, a server, or any of a number of other such devices. The access point 160 may communicate with the devices via short range wireless communication (e.g., Bluetooth, WiFi, and/or the like), and the access point 160 may have a wired or longer range wireless connection to the network 170 and/or to the user equipment 180. Moreover, in some cases, if the user equipment 180 has, for example, Bluetooth communication capabilities, the user equipment 180 could actually act as the access point 160. Thus, for example, in some cases, the access point 160 could be a communication node that provides a gateway to the network 170 so that user equipment that is capable of communication with the network 170 can interface with the connected battery 150 and the devices (via the connected battery 150). However, in other cases, the access point 160 could be a smart phone with Bluetooth capability and the user can interact directly with the connected battery 150 without other network resources therebetween.

As may be appreciated from the discussion above, the connected battery 150 includes circuitry to enable the batteries of the connected battery 150 to be charged (e.g., by the charger 140) and to enable the power from the batteries to be delivered to the devices being powered by the connected battery 150, and also includes communication circuitry to support communication with the access point 160. Thus, the connected battery 150 is configured to be operably coupled to a device on two levels. First, there is a power transfer communication level of connectivity, and secondly there is a data communication level of connectivity. As such, the connected battery 150 can, for example, both provide power to a device and communicate with the device and other external devices or networks. In some cases, the connected battery 150 is configured to extract information about the operation of the device (e.g., operational parameters) that are both related to the power provision function of the connected battery 150 and unrelated to the power provision function of the connected battery 150. Thus, for example, the connected battery 150 may be configured to simultaneously power the device, manage that power provision, extract information from the device and provide the extracted information to the network 170. Moreover, the connected battery 150 may connect the device to a local and/or remote network via which a user may be enabled to appreciate certain performance characteristics of the devices (or operators thereof) or otherwise interact with such devices to enhance maintenance, management or otherwise enhance the user experience.

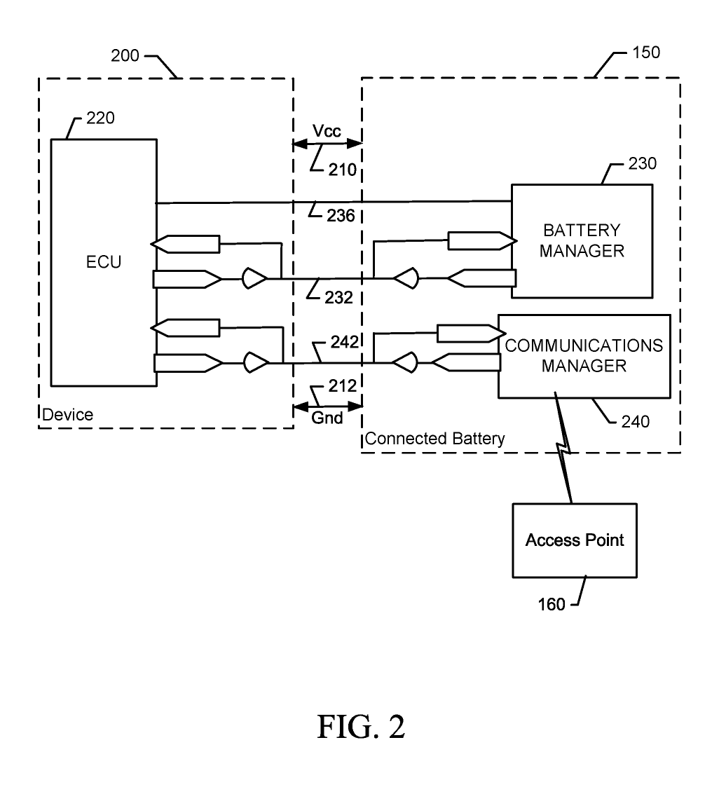

FIG. 2 illustrates a block diagram of the circuitry for accomplishing the two levels of connectivity described above. As shown in FIG. 2, a device 200 (which could be any of the first, second and third devices 110, 120 and 130, or the charger 140, of FIG. 1) is operably coupled to the connected battery 150 via power provision circuitry including power coupling 210 and ground coupling 212. In some cases, the power coupling 210 and the ground coupling 212 may be embodied as electrical contacts that mate with each other when the connected battery 150 is inserted fully into a battery receptacle of the device 200. The power provision circuitry may enable the cells of the connected battery 150 to be coupled to the electric motor of the device 200 (e.g., when the device 200 is one of the first, second and third devices 110, 120 and 130) or to an output of the charger 140 (e.g., when the device 200 is embodied as the charger 140).

The device 200 may include an electronic control unit (ECU) 220, which may include processing circuitry for controlling various components of the device 200. The ECU 220 may control a working assembly (e.g., a blade and/or electric motor) of the device 200 and may also gather data (e.g., operational parameters) from various sensors of the device, or generate or store such data locally as it is available based on operation of the working assembly or other components of the device 200.

The connected battery 150 may include a battery manager 230 configured to manage the power transfer communication level of connectivity between the device 200 and the connected battery 150, and a communications manager 240 configured to manage data communication level of connectivity between the device 200 and the connected battery 150. As part of managing power transfer, the battery manager 230 may institute safe guards based on monitoring data over a battery data line 232. The battery data line 232 may be a serial data connection involving various input/output ports on the ECU 220 and on the battery manager 230. The battery data line 232 may be supplemented by a shutdown line 236 that may operate to protect the device 200 and/or the battery cells of the connected battery 150 by interrupting power transfer if certain shutdown conditions are detected by the battery manager 230. Meanwhile, a separate service line 242 may be provided for transfer of operational parameters regarding device 200 operation that can be passed along to the network 170 of FIG. 1 via the access point 160 by the communications manager 240. The service line 242 may be a serial data line connecting various input/output ports of the ECU 220 to corresponding input/output ports of the communications manager 240.

Of note, although the communications manager 240 and the battery manager 230 are shown as separate entities in FIG. 2, it should be appreciated that they may be embodied on the same or different physical components in various example embodiments. Thus, for example, in some cases, the battery manager 230 may be embodied on a single chip having its own processor and/or processing circuitry and the communications manager 240 may be embodied by a separate chip having separate processor and/or processing circuitry resources. However, in still another example, the connected battery 150 may have a single processing chip that may be configured to act as both the battery manager 230 and the communications manager 240. Additionally, the battery data line 232 and the service data line 242 could also be combined into a single communication interface or bus in some embodiments. Thus, the battery data and service data (e.g., all operational parameters) could pass over a single communication interface or bus in some cases.

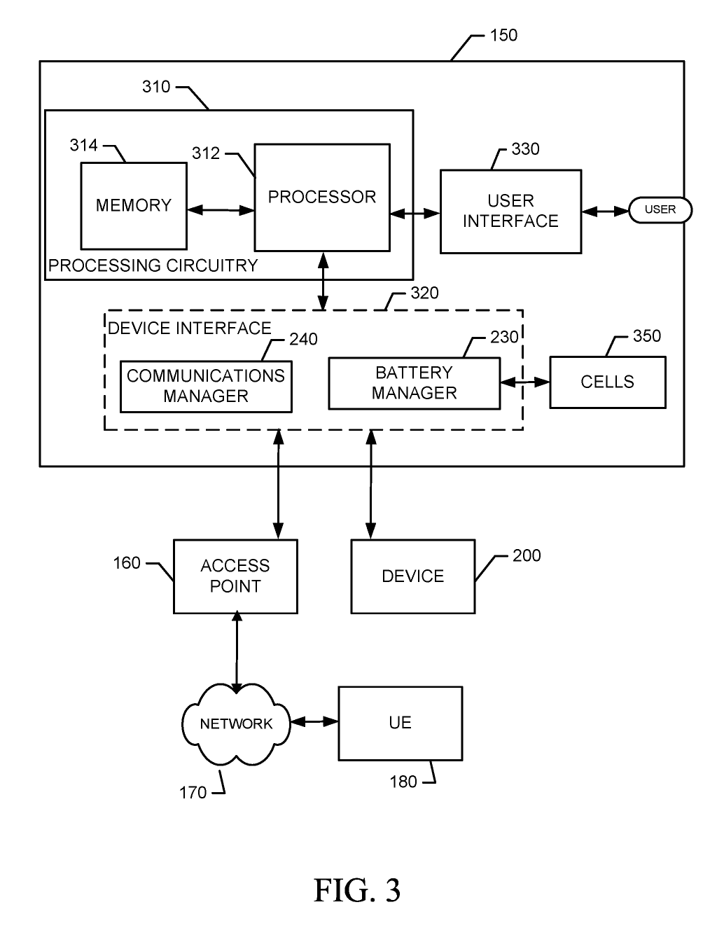

FIG. 3 illustrates a block diagram of the processing circuitry of the connected battery 150 in accordance with an example embodiment. The connected battery 150 may include processing circuitry 310 of an example embodiment as described herein. In this regard, for example, the connected battery 150 may utilize the processing circuitry 310 to provide electronic control inputs to one or more functional units of the connected battery 150 and to process data received at or generated by the one or more functional units regarding various indications of device activity (e.g., operational parameters and/or location information) relating to a corresponding one of the devices 200. In some cases, the processing circuitry 310 may be configured to perform data processing, control function execution and/or other processing and management services according to an example embodiment. However, in other examples, the processing circuitry 310 may be configured to manage extraction, storage and/or communication of data received at the processing circuitry 310.

In some embodiments, the processing circuitry 310 may be embodied as a chip or chip set. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control other components or modules that interface with the processing circuitry 310. As such, the processing circuitry 310 may be embodied as a circuit chip (e.g., an integrated circuit chip) configured (e.g., with hardware, software or a combination of hardware and software) to perform operations described herein. However, in some embodiments, the processing circuitry 310 may be embodied as a portion of an on-board computer housed in a battery pack with the battery manager 230 and/or the communications manager 240 to control operation of the connected battery 150 relative to its interaction with other devices.

Although not required, some embodiments of the connected battery 150 may employ a user interface 330. The user interface 330 may be in communication with the processing circuitry 310 to receive an indication of a user input at the user interface 330 and/or to provide an audible, visual, tactile or other output to the user. As such, the user interface 330 may include, for example, a display, one or more switches, lights, buttons or keys (e.g., function buttons), and/or other input/output mechanisms. In an example embodiment, the user interface 330 may include one or a plurality of colored lights or a simple display to indicate charge status or other relatively basic information. However, more complex interface mechanisms could be provided in some cases.

As shown in FIG. 3, the connected battery 150 may further include the battery manager 230 and the communications manager 240. The battery manager 230 and the communications manager 240 may be embodied as or otherwise controlled by the processing circuitry 310. However, in some cases, the processing circuitry 310 may be associated with only a specific one of the battery manager 230 or the communications manager 240, and a separate instance of processing circuitry may be associated with the other. Yet in some cases, the processing circuitry 310 could be shared between the battery manager 230 and the communications manager 240 and/or the processing circuitry 310 could be configured to instantiate both such entities. Thus, although FIG. 3 illustrates such an instance of sharing the processing circuitry 310 between the battery manager 230 and the communications manager 240, it should be appreciated that FIG. 3 is not limiting in that regard.

Each of the battery manager 230 and the communications manager 240 may employ or utilize components or circuitry that acts as a device interface 320. The device interface 320 may include one or more interface mechanisms for enabling communication with other devices (e.g., device 200, the access point 160, and/or internal components). In some cases, the device interface 320 may be any means such as a device or circuitry embodied in either hardware, or a combination of hardware and software that is configured to receive and/or transmit data from/to components in communication with the processing circuitry 310 via internal communication systems of the connected battery 150. With respect to the communications manager 240, the device interface 320 may further include wireless communication equipment (e.g., a one way or two way radio) for at least communicating information from the connected battery 150 to the access point 160. As such, the device interface 320 of the communications manager 240 may include an antenna and radio equipment for conducting Bluetooth, WiFi, or other short range communication with the access point 160, or for employing other longer range wireless communication protocols for communicating with the access point 160 in instances where the access point 160 is directly associated with provision of access to a wide area network.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein.

In an example embodiment, the processor 312 (or the processing circuitry 310) may be embodied as, include or otherwise control the operation of the connected battery 150 based on inputs received by the processing circuitry 310. As such, in some embodiments, the processor 312 (or the processing circuitry 310) may be said to cause each of the operations described in connection with the connected battery 150 in relation to operation the connected battery 150 relative to undertaking the corresponding functionalities associated therewith responsive to execution of instructions or algorithms configuring the processor 312 (or processing circuitry 310) accordingly.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments of the present invention. For example, the memory 314 could be configured to buffer input data for processing by the processor 312. Additionally or alternatively, the memory 314 could be configured to store instructions for execution by the processor 312. As yet another alternative or additional capability, the memory 314 may include one or more databases that may store a variety of data sets responsive to input from the device 200, or any other functional units or devices from which the connected battery 150 has previously extracted data while powering such devices. Among the contents of the memory 314, applications may be stored for execution by the processor 312 in order to carry out the functionality associated with each respective application. In some cases, the applications may include instructions for recognition of patterns of activity and for initiation of one or more responses to the recognition of any particular pattern of activity as described herein. Additionally or alternatively, the applications may prescribe particular reporting paradigms or protocols for reporting of information from the connected battery 150 to a network device via the communications manager 240.

In some embodiments, the battery manager 230 may be any means such as a device or circuitry embodied in either hardware, or a combination of hardware and software that is configured to receive and/or transmit battery data (e.g., operational parameters) from/to the device 200. The battery manager 230 may also control and/or provide electrical connections and/or interfaces between the cells 350 of the connected battery 150 and the device 200 to monitor power provision parameters and enable the battery manager 230 to implement safety or protective functions as appropriate. The protective functions may be implemented based upon examination of the battery data and comparison of such data to various thresholds or safety limits. Thus, the battery data may, in some cases, be acted upon locally by the battery manager 230. However, alternatively or additionally, the battery data may be provided to the communication manager 240 for transmission to the network 170 (or entities accessible through the network 170). In these and other instances, the battery data may be stored locally prior to such transmission or may be transmitted in real-time (or substantially real-time).

In an example embodiment, the battery manager 230 may receive or generate identification information that correlates the battery data to a specific device (e.g., a specific one of the first device 110, the second device 120, the third device 130, or the charger 140), or to users of such devices. Thus, all data may be transmitted and/or stored in association with the identification information so that such data can be associated with its respective device, device type, or user for analytical purposes. The identification information may include a specific device identifier, a type identifier indicating the type or model of the device 200, and/or a specific user identifier. The battery data may include, for example, information indicative of current draw at discrete intervals, continuously, or at discrete times. Temperature data, maximum current, state of charge, and other data related to the state of the cells 350 or other aspects of the devices 200 or connected battery 150 relative to current draw or battery performance may also be included in the battery data.

In an example embodiment, the communications manager 240 may be any means such as a device or circuitry embodied in either hardware, or a combination of hardware and software that is configured to receive and/or transmit service data from/to the device 200. The communications manager 240 may also control the storage and/or further communication (e.g., relaying) of service data (e.g., operational parameters) extracted from the device 200. Thus, for example, the service data may be extracted from the device 200 to which the connected battery 150 is operably coupled during such coupling. The extracted operational parameters of the service data may then be immediately transmitted (e.g., relayed) to the access point 160 for further provision to the network 170 or devices connected to the network 170 such as the UE 180, or the extracted operational parameters may be temporarily stored prior to later transmission to the access point 160. The service data may include information specific to device performance, at least some of which is not determined based on measuring battery parameters. Thus, for example, the service data may include engine RPM, working assembly RPM, torque, run time or run hours, position, orientation, temperature data, speed data, mode of operation, lubricating oil pressure or level, instances of protective actions, and/or the like.

In some example embodiments, the service data may be used for local analysis and protective action initiation at the device 200. For example, RPM limits may be enforced based on analysis of the RPM data provided via the service data. However, in some embodiments, the data may instead be analyzed at the UE 180 after provision thereto. Corrective or protective instructions may then, in some cases, be provided to the user via a display or other user interface at the UE 180.

Similar to the battery data, the service data may also be transmitted and/or stored in association with the identification information so that all operational parameters (e.g., including both service data and battery data) are associated with a respective device, device type, or user. The identification information may therefore include a specific device identifier, a type identifier indicating the type or model of the device 200, and/or a specific user identifier. In some embodiments, operational parameters may also be transmitted and/or stored in association with temporal information that may indicate the time (or time period) that the operational parameters were obtained from the device 200 and/or the time that the operational parameters were transmitted from the connected battery 150.

The operational parameters may be extracted from the device 200 by the connected battery 150 at regular intervals, continuously, and/or as a response to specific predefined stimuli. After extraction, the communications manager 240 may determine whether to store the data temporarily or relay the operational parameters to the access point 160 in real-time (or substantially in real-time). The relaying may therefore be at the same schedule (e.g., at regular intervals, continuously, and/or in response to the specific predefined stimuli) as the data extraction occurs or may occur at a different schedule. Thus, for example, if the operational parameters are at least temporarily stored, the communications manager 240 may define a separate interval or period at which to communicate the operational parameters to the access point 160. Alternatively or additionally, the communications manager 240 may define different stimuli to trigger transmission of the operational parameters to the access point 160.

As an example, in some cases, insertion or removal of the connected battery 150 into the device 200 may trigger immediate transmission of operational parameters stored in the memory 314 of the connected battery 150 to the access point 160. Thus, the beginning and/or ending of a power provision cycle for the device 200 may trigger the communications manager 240 to transmit operational parameters to the access point 160. The fact that the transmission occurs from the connected battery 150 means that even after the device 200 is left unpowered (and therefore incapable of reporting information about the just completed session) the operational parameters associated with the just completed session can still be reported by the connected battery 150 (which remains powered by the cells 350).

However, if the cells 350 are depleted fully, then the connected battery 150 may not actually be able to transmit the data until power levels are recharged sufficiently. Thus, in some cases, insertion of the connected battery 150 may trigger transmission of the data from an immediately previous session with what is presumably a recharged group of cells 350. Moreover, in some cases, the connected battery 150 may be configured to check to see if operational parameters are available for transmission as soon as recharging of the cells 350 is accomplished to at least a predetermined charge level. Thus, for example, if removal generally triggers transmission, a transmission instruction may be provided at the communications manager 240. However, the communications manager 240 may determine that the power level of the cells 350 is too low to complete transmission of the operational parameters. Thus, the communications manager 240 may provide the transmission instruction, but monitor battery charge status to determine when the cells 350 are sufficiently recharged to support transmission of the operational parameters to carry out the transmission instruction. After battery charge status reaches the predetermined charge level, the communications manager 240 may execute the transmission instruction and report the operational parameters to the access point 160.

As an alternative, an identity based communication trigger may be employed. For example, insertion of the connected battery 150 into the device 200 may trigger an initial identity query whereby the connected battery 150 obtains identification information from the device 200. Once the identification information is received, the connected battery 150 may start a data log for operational parameters associated with the identity provided in the identification information. The connected battery 150 may also determine whether the identification information is different from the prior identification determined from the previous connected battery 150 insertion into a device. In some cases, the transmission instruction may be generated when the comparison of identification information indicates a change in identity. However, as an alternative, the transmission instruction could be generated when the comparison of identification information indicates the same identity.

In some cases, the UE 180 may receive the operational parameters and execute one or more applications on the operational parameters. As such, the UE 180 may include processing circuitry that may be similar in capability and perhaps also structure to the processing circuitry described above. The UE 180 may execute applications for storage and/or analysis of the service and/or battery data. Thus, for example, the UE 180 may be configured to analyze RPM data, engine run hours, and/or various other aspects of the operational parameters to determine when servicing of the device should be performed or when there are technical issues or problems that the operator or a fleet manager should be informed of have occurred. The UE 180 may be configured to provide an alert to the user or fleet manager and the alert may be descriptive of the specific issue that has been identified.

The applications executable at the UE 180 may include an application for reviewing, monitoring, and/or analyzing individual device or device type performance. In some cases, the applications at the UE 180 may include an application for cloud management of tools. Thus, for example, adaptive tool settings, instructions and/or the like may be used to specifically configure tools under specifically identified circumstances or scenarios to maximize control over, for example, a fleet of tools. Guided tool operation may therefore be controlled via the connected battery 150. Applications may also define triggers, codes and/or the like for locking or unlocking tools, and for the extraction of operational data.

In some example embodiments, either the UE 180 or the connected battery 150 may store configuration information specific to the device 200. Thus, for example, the operator may configure the device 200 in a particular way that is desirable by the specific user of the device 200. The configuration information may be input at the device 200 and transmitted for storage at the connected battery 150 and/or at the UE 180. Alternatively, the configuration information may be input at the UE 180 and transmitted to the connected battery 150 for storage and communication to the device 200 when the device 200 is operably coupled to the connected battery 150. The configuration information may provide torque or RPM limits or settings, and such information may be stored to guide operation of the device 200.

Of note, although FIG. 1 shows only one UE 180 it should be appreciated that several could be employed in some embodiments. For example, one UE could be a central node (e.g., a server or computer associated with a particular organization, household, fleet of devices, device manufacturer, and/or the like. Other UEs could be distributed nodes associated with individual users of the devices, or smaller organizations, individual households, and/or the like. The central node may perform analysis of the operational parameters, and generate alerts or processed information that is specific to the devices associated with respective ones on the distributed nodes to each respective UE of the corresponding distributed nodes. Thus, identification information with which the operational parameters are associated could be the discriminating factor to allow the central node to store data. The stored data, on a fleet wide basis or for all devices registered to the manufacturer, may then be analyzed for trends or other specific issues, and individual users or organizations can receive information specific to their devices. However, the information specific to their devices may be benchmarked against the performance of other devices not associated with the individual users or organizations. Thus, the individual users or organizations can determine how hard they run their equipment, how frequently they service their equipment, and/or how well their equipment performs relative to all other equipment monitored by the central node.

As can be appreciated from the example embodiments above, some embodiments may provide a connected battery 150 that can extract operational parameters (e.g., battery data and/or service data) from devices to which the connected battery 150 is operably connectable (e.g., the device 200). That extracted information may be transmitted by the connected battery 150 to the access point 160 and to other devices (e.g., the UE 180) that may be connected to the network 170. Various different communication paradigms and analyses may then be performed on the operational parameters. However, the connected battery 150 becomes the gateway between the device 200 and the network 170 and any devices on the network 170. Because the connected battery 150 is or includes a power source itself, the ability to report information about device operation is more reliably supported than if the device 200 itself was expected to report its operational parameters to some central node.

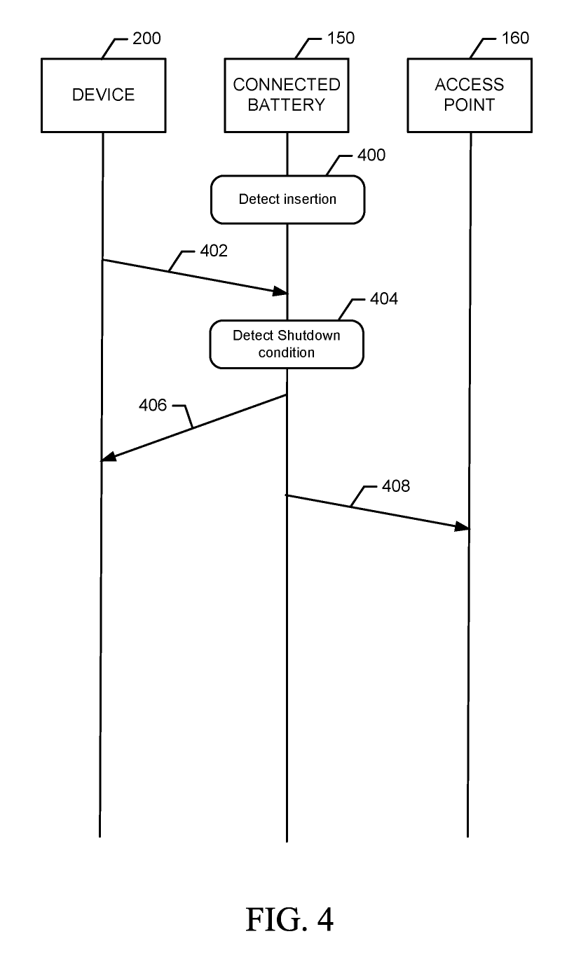

FIGS. 4-8 illustrate various example control flow diagrams illustrating a series of communication operations associated with operation of the connected battery 150 of an example embodiment. As shown in FIG. 4, the connected battery 150 may initially detect insertion into the device 200 at operation 400. Thereafter, operational parameters may be extracted from the device 200 by the connected battery 150 at operation 402. The battery data may indicate a shutdown condition at operation 404 (e.g., current draw above a predetermined threshold). The connected battery 150 may initiate a shutdown to remove power provision to the device 200 at operation 406. At operation 408, the connected battery 150 may report the operational parameters and/or the occurrence of the shutdown condition to the access point 160 at operation 408.

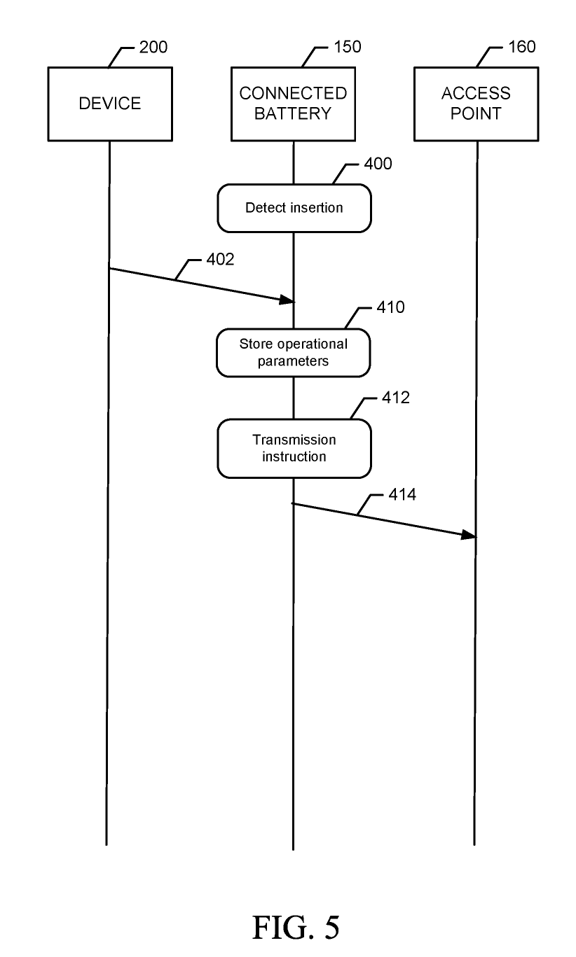

In the example of FIG. 5, the connected battery 150 may initially detect insertion into the device 200 at operation 400. Thereafter, operational parameters may be extracted from the device 200 by the connected battery 150 at operation 402. Operational parameters may be stored in association with identification information at operation 410. At operation 412, a triggering event may be detected to cause the connected battery 150 to generate or execute a transmission instruction. At operation 414, the operational parameters and/or an indication of the triggering event may be transmitted to the access point 160.

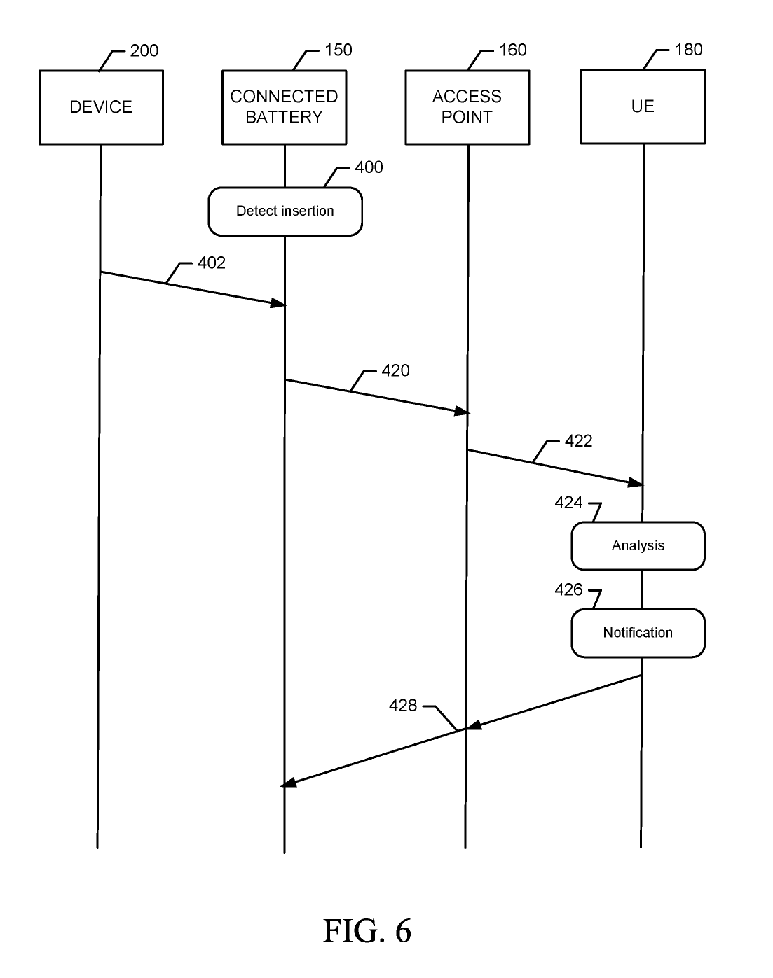

In the example of FIG. 6, the connected battery 150 may initially detect insertion into the device 200 at operation 400. Thereafter, operational parameters may be extracted from the device 200 by the connected battery 150 at operation 402. Operational parameters may be relayed in association with identification information at operation 420 so that the operational parameters are provided in real-time (or substantially in real-time) to the access point 160. Although not required, the access point 160 may provide the operational parameters to the UE 180 (e.g., via the network 170) at operation 422. The UE 180 may perform analysis at operation 424, and may provide a notification to the user at operation 426 and/or provide information or instruction back to the connected battery 150 (via the access point 160) at operation 428.

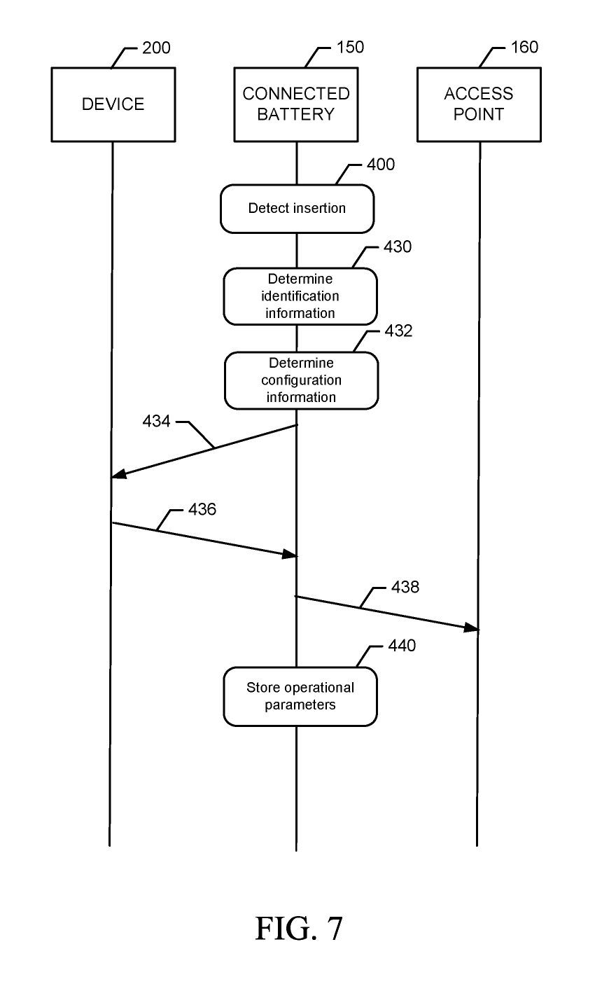

In the example of FIG. 7, the connected battery 150 may initially detect insertion into the device 200 at operation 400. Thereafter, the connected battery 150 determined identification information associated with the device 200 at operation 430. The connected battery 150 then determines configuration information for the device 200 at operation 432. The configuration information is then sent to the device 200 to configure the device 200 accordingly at operation 434. Operational parameters may then be extracted from the device 200 by the connected battery 150 during device operation in accordance with the configuration information at operation 436. Operational parameters may be relayed in association with identification information at operation 438 and/or stored at operation 440. so that the operational parameters are provided in real-time (or substantially in real-time) to the access point 160. Although not required, the access point 160 may provide the operational parameters to the UE 180 (e.g., via the network 170) at operation 422. The UE 180 may perform analysis at operation 424, and may provide a notification to the user at operation 426 and/or provide information or instruction back to the connected battery 150 (via the access point 160) at operation 428.

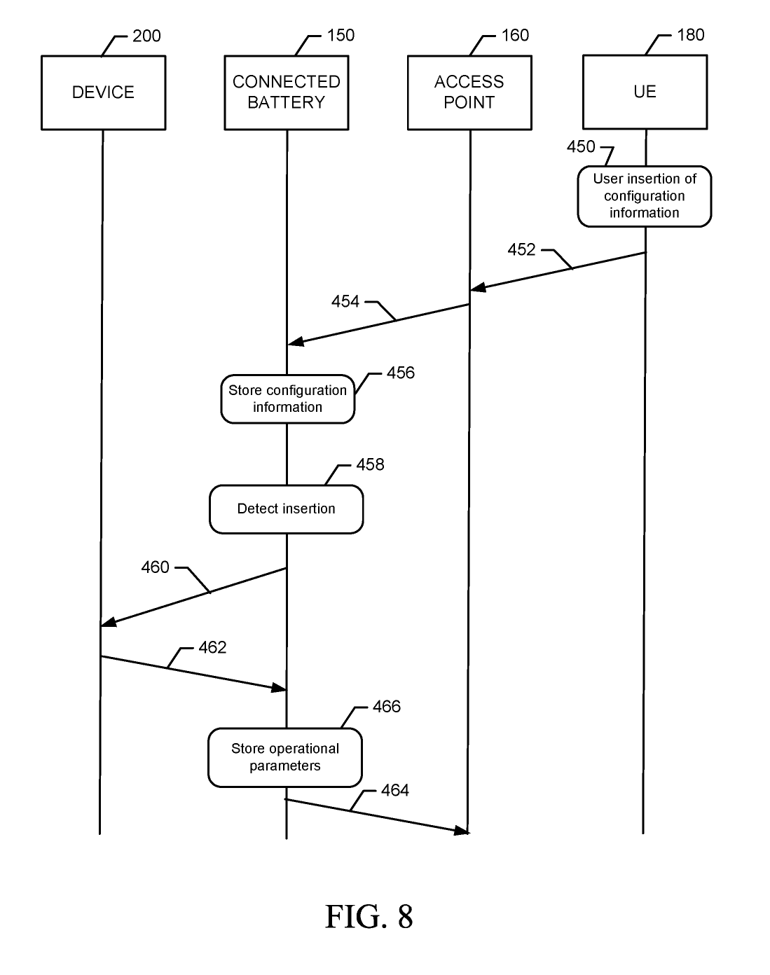

In the example of FIG. 8, the user may insert configuration information into the UE 180 to configure the device 200 at operation 450. The UE 180 may provide the configuration information to the access point 160 at operation 452, and the access point 160 may provide the configuration information to the connected battery 150 at operation 454. The configuration information may then be stored at the connected battery 150 at operation 456. Thereafter, insertion of the connected battery 150 into the device 200 for which the configuration information is intended may be detected at operation 458. The connected battery 150 may then provide the configuration information to the device 200 to configure the device 200 accordingly at operation 460. Thereafter, operational parameters may be extracted from the device 200 by the connected battery 150 during device operation in accordance with the configuration information at operation 462. Operational parameters may be relayed in association with identification information at operation 464 and/or stored at operation 466.

Accordingly, in one example embodiment, a battery pack that may include one or more rechargeable battery cells and processing circuitry. The processing circuitry may be configured to control extraction of operational parameters from a device to which the battery pack is operably coupled and wireless communication of the operational parameters from the battery pack to an access point. The operational parameters may include at least one parameter that is not determined based on measuring battery parameters. The device is one of a plurality of different devices with which the battery pack is configured to be operably coupled.

In some cases, modifications or amplifications may further be employed as optional alterations or augmentations to the description above. These alterations or augmentations may be performed exclusive of one another or in any combination with each other. In some cases, such modifications or amplifications may include (1), the operational parameters may include battery data and service data. In an example embodiment (2), the battery data may include current data, state of charge, or temperature data, and the processing circuitry may be configured to initiate a protective function based upon comparing the battery data to a predetermined threshold. In some cases (3), the service data may include RPM data, torque, run time, device position, device orientation, temperature data, speed data, mode of operation, or an instance of a protective action. In some embodiments (4), the wireless communication of the operational parameters may be performed substantially in real-time relative to extraction of the operational parameters. In an example embodiment (5), the operational parameters may be stored at a memory of the processing circuitry prior to wireless communication of the operational parameters. In some cases (6), the operational parameters may be stored in association with identification information indicative of a device identity, device type or user identity. In some embodiments (7), a transmission instruction may be generated to direct the wireless communication based at least in part on the identification information. In an example embodiment (8), the operational parameters may be stored in association with temporal information indicative of a time or time period at which the operational parameters were extracted from the device. In some cases (9), the operational parameters may be stored at a memory of the processing circuitry, and the wireless communication may be executed in response to a predetermined level of charge of the battery cells being achieved. In some embodiments (10), the processing circuitry may be configured to receive configuration information for configuring the device from a user via the access point. In some cases (11), the configuration information may be stored at the processing circuitry and loaded onto the device in response to detection of installation of the battery pack in the device. In some embodiments (12), the access point may provide access to a network, and user equipment may be enabled to interact with the processing circuitry via the network and the access point. In some cases (13), the access point may provide a user with access to interact with the processing circuitry to receive alerts associated with the device or to provide an instruction for operation of the device.

In an example embodiment, some, any or all of modifications/amplifications (1) to (13) may be employed in any combination with each other.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A battery pack comprising:
one or more rechargeable battery cells;
and processing circuitry configured to control:
extraction of operational parameters from a device to which the battery pack is operably coupled, the operational parameters comprising at least one parameter that is not determined based on measuring battery parameters; and
wireless communication of the operational parameters from the battery pack to an access point,
wherein the device is one of a plurality of different devices with which the battery pack is configured to be operably coupled.

2. The battery pack of claim 1, wherein the operational parameters comprise battery data and service data.

3. The battery pack of claim 2, wherein the battery data comprises current data, state of charge, or temperature data, and wherein the processing circuitry is configured to initiate a protective function based upon comparing the battery data to a predetermined threshold.

4. The battery pack of claim 2, wherein the service data comprises RPM data, torque, run time, device position, device orientation, temperature data, speed data, mode of operation, or an instance of a protective action.

5. The battery pack of claim 1, wherein the wireless communication of the operational parameters is performed substantially in real-time relative to extraction of the operational parameters.

6. The battery pack of claim 1, wherein the operational parameters are stored at a memory of the processing circuitry prior to wireless communication of the operational parameters.

7. The battery pack of claim 6, wherein the operational parameters are stored in association with identification information indicative of a device identity, device type or user identity.

8. The battery pack of claim 7, wherein a transmission instruction is generated to direct the wireless communication based at least in part on the identification information.

9. The battery pack of claim 6, wherein the operational parameters are stored in association with temporal information indicative of a time or time period at which the operational parameters were extracted from the device.

10. The battery pack of claim 1, wherein the operational parameters are stored at a memory of the processing circuitry, and wherein the wireless communication is executed in response to a predetermined level of charge of the battery cells being achieved.

11. The battery pack of claim 1, wherein the processing circuitry configured to receive configuration information for configuring the device from a user via the access point.

12. The battery pack of claim 11, wherein the configuration information is stored at the processing circuitry and loaded onto the device in response to detection of installation of the battery pack in the device.

13. The battery pack of claim 1, wherein the access point provides access to a network, and wherein user equipment is enabled to interact with the processing circuitry via the network and the access point.

14. The battery pack of claim 1, wherein the access point provides a user with access to interact with the processing circuitry to receive alerts associated with the device or to provide an instruction for operation of the device.

15. A communications manager for a battery pack comprising one or more rechargeable battery cells, the communications manager comprising:
processing circuitry configured to control:
extraction of operational parameters from a device to which the battery pack is operably coupled, the operational parameters comprising at least one parameter that is not determined based on measuring battery parameters; and
wireless communication of the operational parameters from the battery pack to an access point,
wherein the device is one of a plurality of different devices with which the battery pack is configured to be operably coupled.

16. The communications manager of claim 15, wherein the operational parameters comprise battery data and service data.

17. The communications manager of claim 16, wherein the battery data comprises current data, state of charge, or temperature data, and wherein the processing circuitry is configured to initiate a protective function based upon comparing the battery data to a predetermined threshold.

18. The communications manager of claim 16, wherein the service data comprises RPM data, torque, run time, device position, device orientation, temperature data, speed data, mode of operation, or an instance of a protective action.

19. The communications manager of claim 15, wherein the wireless communication of the operational parameters is performed substantially in real-time relative to extraction of the operational parameters.

20-26. (canceled)

27. A system comprising:
a plurality of different devices, each of the devices comprising outdoor power equipment that is battery powered;
an access point configured for wireless communication; and
a battery pack comprising one or more rechargeable battery cells and processing circuitry configured to control:
extraction of operational parameters from a selected one of the devices to which the battery pack is operably coupled, the operational parameters comprising at least one parameter that is not determined based on measuring battery parameters; and
wireless communication of the operational parameters from the battery pack to the access point.

28. (canceled)
